(19) United States
(12) Patent Application Publication
(10) Pub. No.: US 2022/0174408 A1
(43) Pub. Date: Jun. 2, 2022

(54) VOICE DIAPHRAGM FORMING DEVICE AND METHOD

(71) Applicant: AAC Microtech (Changzhou) Co., Ltd., Changzhou City (CN)

(72) Inventors: Chongdeng Wu, Shenzhen (CN); Weiguo Zhou, Shenzhen (CN); Peng Qin, Shenzhen (CN)

(21) Appl. No.: 17/535,721

(22) Filed: Nov. 26, 2021

(30) Foreign Application Priority Data
Nov. 27, 2020 (CN) 202011359696.9

(51) Int. Cl. H04R 7/12; H04R 9/04

(52) U.S. Cl. CPC H04R 7/12; H04R 9/022; H04R 9/045

(57) ABSTRACT

A voice diaphragm forming device and a method are provided. The device includes: a base provided with a first mounting space, where the first mounting space is provided with a mold assembly and a heating and cooling member, the mold assembly is configured to carry a to-be-formed voice diaphragm, and the heating and cooling member is configured to heat and cool the mold assembly; a top cover provided with a second mounting space, where the first mounting space and the second mounting space communicate with each other, and the top cover or the base is provided with a gas inlet; a heating mechanism configured to heat the to-be-formed voice diaphragm; and a gas inlet mechanism. During voice diaphragm forming, the heating mechanism works outside the mold assembly to directly heat the to-be-formed voice diaphragm. This reduces heating time and forming time, thereby improving production efficiency and reducing production costs.

### TECHNICAL FIELD

The present disclosure relates to the field of speakers, in particular to a voice diaphragm forming device and method.

### BACKGROUND

A speaker is a transducer that converts electrical signals into sound signals. A voice diaphragm is a vibration part of the speaker, which is an important element for electro-acoustic conversion.

At present, during voice diaphragm forming, the mold is generally heated by a heating rod inside the mold, the voice diaphragm is pressed against the mold by a gas, and the voice diaphragm is heated by the mold. After the molding is completed, cold water is introduced into the mold to cool the mold, so as to cool the voice diaphragm. In this forming method, the temperature rises slowly, which results in long time for forming the voice diaphragm and high energy consumption, thereby leading to low production efficiency and large costs.

### SUMMARY

The present disclosure provides a voice diaphragm forming device and method, which can reduce the heating time, and further reduce the forming time, thereby improving production efficiency and reducing production costs.

An embodiment of the present disclosure provides a voice diaphragm forming device, including: a base provided with a first mounting space, where the first mounting space is provided therein with a mold assembly and a heating and cooling member, the mold assembly is configured to carry a to-be-formed voice diaphragm, and the heating and cooling member is configured to heat and cool the mold assembly; a top cover covering the base and provided with a second mounting space, where the first mounting space and the second mounting space communicate with each other to form a sealed space, and the top cover or the base is provided with a gas inlet communicating with the sealed space; a heating mechanism arranged in the second mounting space and configured to heat the to-be-formed voice diaphragm; and a gas inlet mechanism configured to introduce a gas into the sealed space through the gas inlet, such that the to-be-formed voice diaphragm is formed on the mold assembly.

As an improvement, the heating mechanisms are infrared heaters.

As an improvement, a spacer is provided in the second mounting space to divide the second mounting space into a mounting chamber and a sealed chamber, the heating mechanism is arranged in the mounting chamber, and the sealed chamber communicates with the gas inlet and the first mounting space respectively.

As an improvement, the top cover includes a sealing base and a mounting base, the sealing base is provided with the sealed chamber and covers the base, the mounting base is connected to the sealing base and provided with the mounting chamber, and the spacer is provided between the sealing base and the mounting base.

As an improvement, the voice diaphragm forming device further includes a heat dissipation assembly configured to absorb heat from the heating and cooling member and/or the mold assembly when the heating and cooling member cools the mold assembly.

As an improvement, the heat dissipation assembly includes a heat dissipation element and an air supply mechanism; the heat dissipation element is arranged in the first mounting space and is configured to absorb the heat from the heating and cooling member and/or the mold assembly; and the air supply mechanism is configured to supply air to the heat dissipation elements.

As an improvement, the base is provided with an air inlet and an air outlet respectively communicating with the first mounting space, and the air supply mechanism supplies air into the first mounting space through the air inlet and exhausts air through the air outlet.

As an improvement, the mold assembly includes a heat dissipation base, a mold core and a diaphragm plate, the mold core is arranged on the heat dissipation base, and the diaphragm plate is provided on the mold core and is configured to carry the to-be-formed voice diaphragm.

As an improvement, the voice diaphragm forming device further includes a pressure mechanism, and the pressure mechanism is connected to the top cover to apply pressure to the top cover against the base.

An embodiment of the present disclosure further provides a voice diaphragm forming method based on the voice diaphragm forming device as described above, and the method includes: heating, by the heating and cooling member, the mold assembly; heating, by the heating mechanism, the to-be-formed voice diaphragm; introducing, by the gas inlet mechanism, a gas into the sealed space through the gas inlet, such that the to-be-formed voice diaphragm is formed on the mold assembly; and cooling, by the heating and cooling member, the mold assembly.

The present disclosure has the following beneficial effects. Different from the prior art, the voice diaphragm forming device provided by the embodiments of the present disclosure includes: a base provided with a first mounting space, where the first mounting space is provided therein with a mold assembly and a heating and cooling member, the mold assembly is configured to carry a to-be-formed voice diaphragm, and the heating and cooling member is configured to heat and cool the mold assembly; a top cover covering the base and provided with a second mounting space, where the first mounting space and the second mounting space communicate with each other to form a sealed space, and the top cover or the base is provided with a gas inlet communicating with the sealed space; a heating mechanism arranged in the second mounting space and configured to heat the to-be-formed voice diaphragm; and a gas inlet mechanism configured to introduce a gas into the sealed space through the gas inlet, such that the to-be-formed voice diaphragm is formed on the mold assembly. During voice diaphragm forming, the heating mechanism works outside the mold assembly to directly heat the to-be-formed voice diaphragm. This reduces the heating time and voice diaphragm forming time, thereby improving production efficiency and reducing production costs.

### BRIEF DESCRIPTION OF DRAWINGS

To describe the technical solutions in the embodiments of the present disclosure more clearly, the drawings required for describing the embodiments are briefly described below. Apparently, the drawings in the following description show merely some embodiments of the present disclosure, and those of ordinary skill in the art may still derive other drawings from these drawings without creative efforts.

FIG. 1 is a three-dimensional view illustrating a structure of a voice diaphragm forming device 10 according to an embodiment of the present disclosure;

FIG. 2 is an exploded view of the voice diaphragm forming device 10 shown in FIG. 1;

FIG. 3 is a sectional view taken along line A-A shown in FIG. 1; and

FIG. 4 is a flowchart of a voice diaphragm forming method according to an embodiment of the present disclosure.

### DETAILED DESCRIPTION OF EMBODIMENTS

The technical solutions of the embodiments of the present disclosure are described in detail below with reference to the drawings. Apparently, the described embodiments are merely some rather than all of the embodiments of the present disclosure. All other embodiments obtained by those of ordinary skill in the art based on the embodiments of the present disclosure without creative efforts should fall within the protection scope of the present disclosure.

It should be noted that all directional indications (such as upper, lower, left, right, front and back) in the implementations of the present disclosure are merely intended to explain relative position relationships or motions of components in specific positions (shown in the drawings). If the specific positions change, the directional indications change accordingly.

It should also be noted that when a component is “fixed to” or “provided on” the other component, the component may be “fixed” to or “provided” on the other component directly or via an intermediate component. When a component is “connected” to the other component, the component may be “connected” to the other component directly or via an intermediate component.

Moreover, the terms such as “first” and “second” used herein are merely for a purpose of description and are not intended to indicate or imply relative importance, or implicitly indicate the number of the indicated technical features. Therefore, features defined by “first” and “second” may explicitly or implicitly include at least one of the features. Further, the technical solutions of the various implementations may be combined with each other on the basis that the combination is implementable by those of ordinary skill in the art. In case a combination of the technical solutions is contradictory or infeasible, such a combination is deemed inexistent and not falling within the protection scope of the present disclosure.

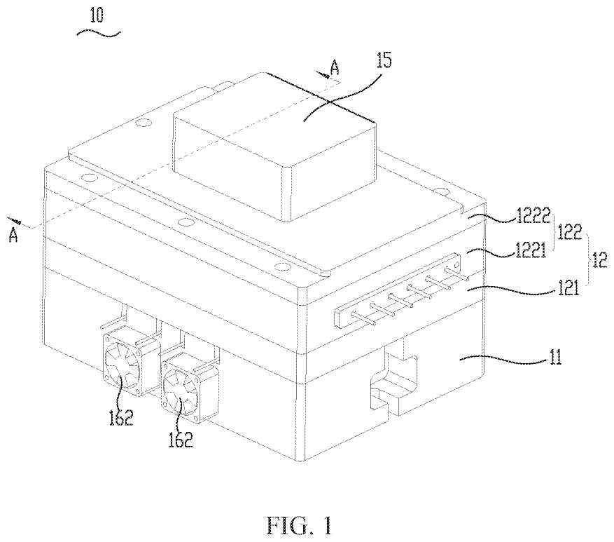

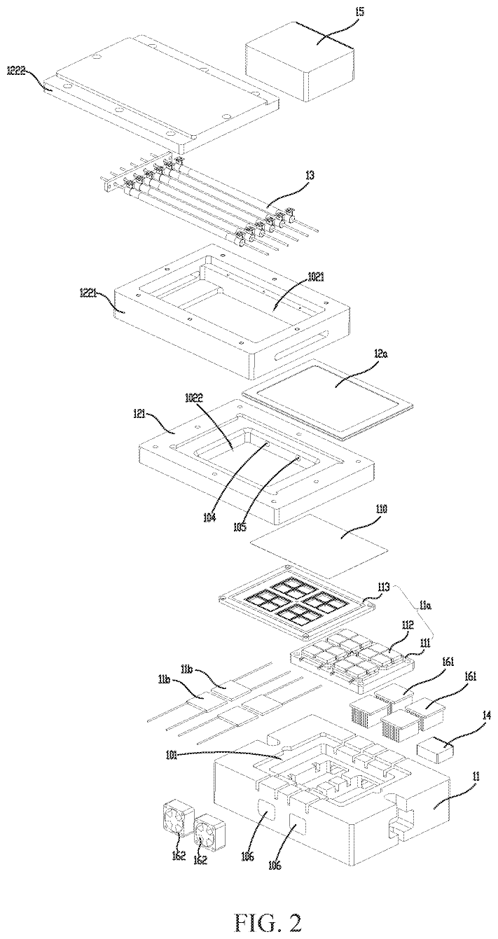

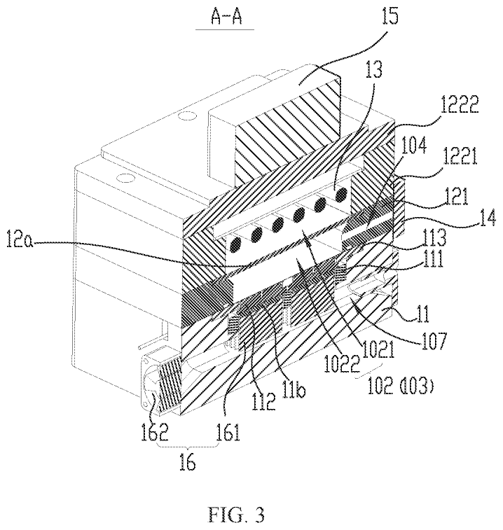

Refer to FIG. 1 to FIG. 3, FIG. 1 is a three-dimensional view illustrating a structure of a voice diaphragm forming device 10 according to an embodiment of the present disclosure; FIG. 2 is an exploded view of the voice diaphragm forming device 10 shown in FIG. 1; and FIG. 3 is a sectional view taken along line A-A shown in FIG. 1. In an embodiment of the present disclosure, the voice diaphragm forming device 10 includes a base 11, a top cover 12, a heating mechanism 13 and a gas inlet mechanism 14.

The base 11 is provided with a first mounting space 101, and the first mounting space 101 is provided therein with a mold assembly 11a and a heating and cooling member 11b.

The mold assembly 11a is used to carry the voice diaphragm 110 to be formed. In this implementation, the mold assembly 11a includes a heat dissipation base 111, a mold core 112 and a diaphragm plate 113. The mold core 112 is arranged on the heat dissipation base 111, and the diaphragm plate 113 is provided on the mold core 112 and is used to carry the voice diaphragm 110 to be formed.

In an embodiment, the heat dissipation base 111 is provided with multiple mold core holes. Multiple mold cores 112 are provided and located in the multiple mold core holes. For example, in this implementation, four mold core holes and four mold cores 112 are provided.

In an embodiment, the heat dissipation base 111 is a ceramic base to improve the heat dissipation effect. In other implementations, the heat dissipation base 111 may also be made of other heat dissipation material.

Further, the heating and cooling member 11b is used to heat and cool the mold assembly 11a. In this implementation, the heating and cooling member 11b is attached to a side of the mold cores 112 away from the diaphragm plate 113.

In an embodiment, the heating and cooling member 11b is a semiconductor cooling plate. When a positive current is applied to the semiconductor cooling plate, the mold assembly 11a is heated, and when a negative current is applied to the semiconductor cooling plate, the mold assembly 11a is cooled. In other implementations, the heating and cooling member 11b may achieve heating and cooling of the mold assembly 11a in other manners, which is not limited herein.

In an embodiment, multiple heating and cooling members 11b are provided to improve the cooling effect. The multiple heating and cooling members 11b are respectively attached to the sides of the multiple mold cores 112 away from the diaphragm plate 113.

The top cover 12 covers the base 11 and a second mounting space 102 is formed. The first mounting space 101 communicates with the second mounting space 102 to form a sealed space 103.

In an embodiment, the voice diaphragm forming device further includes a pressure mechanism 15. The pressure mechanism 15 is connected to the top cover 12 to apply pressure to the top cover 12 against the base 11. After the top cover 12 covers the base 11, the top cover 12 is subjected to the pressure exerted by the pressure mechanism 15, such that the first mounting space 101 and the second mounting space 102 form a seal at a communication position, thereby forming the sealed space 103. In other implementations, the manner of forming the sealed space 103 is not limited herein, for example, a sealing ring may be provided at the communication position between the first mounting space 101 and the second mounting space 102.

Further, the top cover 12 or the base 11 is provided with a gas inlet 104 communicating with the sealed space 103. The gas inlet 104 is used to introduce a gas into the sealed space 103.

In an embodiment, the top cover 12 or the base 11 is further provided with a gas outlet 105 communicating with the sealed space 103. The gas outlet 105 is used to discharge the gas introduced into the sealed space 103.

Further, a spacer 12a is provided in the second mounting space 102. The spacer 12a divides the second mounting space 102 into a mounting chamber 1021 and a sealed chamber 1022. The sealed chamber 1022 communicates with the gas inlet 104 and the first mounting space 101 respectively. That is, in this implementation, the gas inlet 104 is provided in the top cover 12.

In an embodiment, the top cover 12 includes a sealing base 121 and a mounting base 122. The sealing base 121 is provided with the sealed chamber 1022 and covers the base 11. The mounting base 122 is connected to the sealing base 121 and the mounting chamber 1021 is formed. The spacer 12a is provided between the sealing base 121 and the mounting base 122. In order to improve the sealing effect of the sealed chamber 1022, a position where the spacer 12a is arranged may be sealed, for example, by a sealing ring.

In an embodiment, the mounting base 122 includes a support 1221 and a cover plate 1222. The support 1221 is provided with the mounting chamber 1021 and is connected to the sealing base 121. The cover plate 1222 is connected, at a side of the support 1221 away from the sealing base 121, to the support 1221.

The heating mechanism 13 is provided in the second mounting space 102 and used to heat the voice diaphragm 110 to be formed.

In an embodiment, the heating mechanism 13 is an infrared heater, which heats up quickly and save energy, thereby improving production efficiency and reducing costs.

In an embodiment, multiple heating mechanisms 13 are provided. The number of the heating mechanisms 13 depends on actual needs, and is not limited herein.

The gas inlet mechanism 14 is used to introduce a gas into the sealed space 103 through the gas inlet 104, such that the voice diaphragm 110 to be formed is formed on the mold assembly 11a.

Specifically, when the voice diaphragm 110 to be formed is carried on the mold assembly 11a, the heating and cooling member 11b works to heat the mold assembly 11a to a first preset temperature, the heating mechanism 13 works to heat the to-be-formed voice diaphragm 110 to a second preset temperature. The gas inlet mechanism 14 introduces the gas into the sealed space 103 through the gas inlet 104, such that the to-be-formed voice diaphragm 110 is tightly attached to the mold assembly 11a under the action of a gas pressure and then formed on the mold assembly 11a.

In this implementation, the to-be-formed voice diaphragm 110 is carried and formed on the diaphragm plate 113. The gas inlet mechanism 14 introduces a high-pressure gas into the sealed chamber 1022 through the gas inlet 104. Meanwhile, the high-pressure gas is separated from the heating mechanism 13 by the spacer 12a, which is, for example, a quartz spacer, so as to prevent the high-pressure gas from damaging the heating mechanism 13, thereby improving the protection effect on the heating mechanism 13.

Further, after the to-be-formed voice diaphragm 110 is formed on the mold assembly 11a, the heating and cooling member 11b cools the mold assembly 11a. After the cooling process is completed, the top cover 12 is removed, and the formed voice diaphragm can be taken out.

In an embodiment, the voice diaphragm forming device 10 further includes a heat dissipation assembly 16. The heat dissipation assembly 16 is used to absorb heat from the heating and cooling member 11b and/or the mold assembly 11a when the heating and cooling member 11b cools the mold assembly 11a, so as to dissipate heat from the mold assembly 11a. In this way, the cooling effect of the mold assembly 11a is improved, and the cooling time is reduced.

In an embodiment, the heat dissipation assembly 16 includes a heat dissipation element 161 and an air supply mechanism 162. The heat dissipation element 161 is arranged in the first mounting space 101 and is used to absorb heat from the heating and cooling members 11b and/or the mold assembly 11a. In this implementation, the heat dissipation element 161 is attached to a side of the heating and cooling member 11b away from the mold core 112. The air supply mechanism 162 is used to supply air to the heat dissipation element 161 to improve the heat dissipation effect of the heat dissipation element 161. In this way, the cooling effect of the mold assembly 11a is improved, and the cooling time is reduced.

In this implementation, the base 11 is provided with an air inlet 106 and an air outlet 107 respectively communicating with the first mounting space 101. The air supply mechanism 162 supplies air into the first mounting space 101 through the air inlet 106 and exhausts air through the air outlet 107.

In an embodiment, the heat dissipation element 161 is a heat dissipation plate, and the air supply mechanism 162 is a fan.

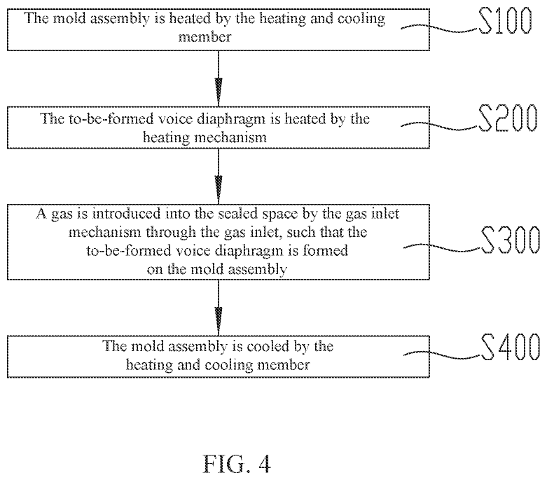

FIG. 4 is a flowchart of a voice diaphragm forming method according to an embodiment of the present disclosure, which is based on the voice diaphragm forming device 10 in the above implementation of the present disclosure. With reference to FIG. 4, the voice diaphragm forming method includes following steps.

At S100l, the mold assembly is heated by the heating and cooling member.

At S200, the to-be-formed voice diaphragm is heated by the heating mechanism.

At S300, a gas is introduced into the sealed space by the gas inlet mechanism through the gas inlet, such that the to-be-formed voice diaphragm is formed on the mold assembly.

At S400, the mold assembly is cooled by the heating and cooling member.

It is understandable that the specific implementation process and principles of steps S100 to S400 can be referred to the corresponding description of the voice diaphragm forming device 10, which will not be repeated here.

Different from the prior art, the voice diaphragm forming device provided by the embodiments of the present disclosure includes: a base provided with a first mounting space, where the first mounting space is provided therein with a mold assembly and a heating and cooling member, the mold assembly is configured to carry a to-be-formed voice diaphragm, and the heating and cooling member is configured to heat and cool the mold assembly; a top cover covering the base and provided with a second mounting space, where the first mounting space and the second mounting space communicate with each other to form a sealed space, and the top cover or the base is provided with a gas inlet communicating with the sealed space; a heating mechanism arranged in the second mounting space and configured to heat the to-be-formed voice diaphragm; and a gas inlet mechanism configured to introduce a gas into the sealed space through the gas inlet, such that the to-be-formed voice diaphragm is formed on the mold assembly. During voice diaphragm forming, the heating mechanism works outside the mold assembly to directly heat the to-be-formed voice diaphragm. This reduces the heating time and voice diaphragm forming time, thereby improving production efficiency and reducing production costs.

The above described are merely implementations of the present disclosure, which do not constitute a limitation on the scope of the present patent application. Any equivalent structure or equivalent process change made based on the description and drawings of the present disclosure, or direct or indirect application thereof in other related technical fields, should still fall in the protection scope of the patent of the present disclosure.

What is claimed is:

1. A voice diaphragm forming device, comprising:
a base provided with a first mounting space, wherein the first mounting space is provided therein with a mold assembly and a heating and cooling member, the mold assembly is configured to carry a to-be-formed voice diaphragm, and the heating and cooling member is configured to heat and cool the mold assembly;
a top cover covering the base and provided with a second mounting space, wherein the first mounting space and the second mounting space communicate with each other to form a sealed space, and the top cover or the base is provided with a gas inlet communicating with the sealed space;
a heating mechanism arranged in the second mounting space and configured to heat the to-be-formed voice diaphragm; and
a gas inlet mechanism configured to introduce a gas into the sealed space through the gas inlet, such that the to-be-formed voice diaphragm is formed on the mold assembly.

2. The voice diaphragm forming device as described in claim 1, wherein the heating mechanisms are infrared heaters.

3. The voice diaphragm forming device as described in claim 1, wherein a spacer is provided in the second mounting space to divide the second mounting space into a mounting chamber and a sealed chamber, the heating mechanism is arranged in the mounting chamber, and the sealed chamber communicates with the gas inlet and the first mounting space respectively.

4. The voice diaphragm forming device as described in claim 3, wherein the top cover comprises a sealing base and a mounting base, the sealing base is provided with the sealed chamber and covers the base, the mounting base is connected to the sealing base and provided with the mounting chamber, and the spacer is provided between the sealing base and the mounting base.

5. The voice diaphragm forming device as described in claim 1, wherein the voice diaphragm forming device further comprises a heat dissipation assembly configured to absorb heat from the heating and cooling member and/or the mold assembly when the heating and cooling member cools the mold assembly.

6. The voice diaphragm forming device as described in claim 5, wherein the heat dissipation assembly comprises a heat dissipation element and an air supply mechanism; the heat dissipation element is arranged in the first mounting space and is configured to absorb the heat from the heating and cooling member and/or the mold assembly; and the air supply mechanism is configured to supply air to the heat dissipation elements.

7. The voice diaphragm forming device as described in claim 6, wherein the base is provided with an air inlet and an air outlet respectively communicating with the first mounting space, and the air supply mechanism supplies air into the first mounting space through the air inlet and exhausts air through the air outlet.

8. The voice diaphragm forming device as described in claim 1, wherein the mold assembly comprises a heat dissipation base, a mold core and a diaphragm plate, the mold core is arranged on the heat dissipation base, and the diaphragm plate is provided on the mold core and is configured to carry the to-be-formed voice diaphragm.

9. The voice diaphragm forming device as described in claim 1, further comprising a pressure mechanism, wherein the pressure mechanism is connected to the top cover to apply pressure to the top cover against the base.

10. A voice diaphragm forming method based on the voice diaphragm forming device as described in claim 1, wherein the method comprises:
heating, by the heating and cooling member, the mold assembly;
heating, by the heating mechanism, the to-be-formed voice diaphragm;
introducing, by the gas inlet mechanism, a gas into the sealed space through the gas inlet, such that the to-be-formed voice diaphragm is formed on the mold assembly; and
cooling, by the heating and cooling member, the mold assembly.
